(19) United States
(12) Patent Application Publication
(10) Pub. No.: US 2007/0191078 A1
(43) Pub. Date: Aug. 16, 2007

(54) Mobile communication device

(75) Inventor: Young S. Kim, Los Altos, CA (US)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/651,888

(22) Filed: Jan. 10, 2007

Related U.S. Application Data
(60) Provisional application No. 60/758,005, filed on Jan. 10, 2006.

(51) Int. Cl. H04M 1/00

(52) U.S. Cl. 455/575.4

(57) ABSTRACT

Disclosed herein is a mobile communication device that includes a first device body having an Liquid Crystal Display (LCD) and being elongate in a lengthwise direction thereof; a second device body rotatably connected to the first device body by a hinge provided to a widthwise edge of the first device body so that the second device body can be rotated about the hinge relative to the first device body to be opened and closed with respect to the first device body; a keypad arranged on the second device body and exposed to the outside when the second device body is closed and faces the first device body; and first and second key arrays arranged on the first device body and exposed to the outside when the second device body is rotated and opened from the first device body.

### PRIORITY

This application claims priority under 35 U.S.C. § 119 to an application” filed in the United States Patent and Trademark Office on Jan. 10, 2006 and assigned Provisional Application No. 60/758,005, and to an application filed in the Korean Intellectual Property Office on Aug. 3, 2006 and assigned Serial No. 2006-73328, the contents of which are incorporated herein by reference.

### BACKGROUND OF THE INVENTION

1. Field of the Invention

The present invention relates to a mobile communication device, and in particular, to a mobile communication device, which is constructed to be used under a communication mode as well as a game mode and a camera mode.

2. Description of the Related Art

As is well known in the conventional art, a mobile communication device is an electronic device which can implement wirelessly communicate with another party while being carried by a user. Mobile communication devices include a Hand Held Product (HHP), a CT-2 cellular phone, a digital phone, a Personal Communication System (PCS) phone, and a Personal Digital Assistant (PDA). Mobile communication devices are divided into various types depending upon configurations thereof. For example, mobile communication devices are divided into a bar type, a flip type and a folder type depending upon configurations thereof. In the bar type mobile communication device, a single device body is formed in the shape of a bar. In the flip type mobile communication device, a flip or a cover is rotatably connected to a bar-shaped device body via a hinge. In the folder type mobile communication device, a folder is rotatably connected to a single bar-shaped device body via a hinge to be folded to and unfolded from the device body.

These conventional mobile communication devices necessarily include an antenna, a data input and output units, and a data transmission unit and a data reception unit. In general, the data input unit includes a keypad through which data can be inputted by pressing keys, e.g. using fingers. The data output unit for performing a display function generally includes a Liquid Crystal Display (LCD).

The conventional mobile communication device has a problem in that it can be used only under a communication mode and does not have any other modes.

When game and camera modes are added to the conventional mobile communication device to overcome the above-mentioned problem, this increases the volume of the mobile communication device, and it is difficult to miniaturize the mobile communication device.

### SUMMARY OF THE INVENTION

Accordingly, the present invention has been made to solve the above-mentioned problems occurring in the conventional art, and an object of the present invention is to provide a mobile communication device, which is constructed to be used under a communication mode as well as a game mode and a camera mode.

Another object of the present invention is to provide a mobile communication device, which is constructed to allow the front and rear surfaces of respective device bodies to be selectively used depending upon a particular use of the mobile communication device, so that the mobile communication device can be conveniently used under various modes, in particular, a game mode, and the miniaturization of the mobile communication device is not adversely influenced by the addition of the various modes.

In order to achieve an aspect of the present invention, there is provided a mobile communication device having a first device body having an LCD and being elongate in a lengthwise direction thereof; a second device body rotatably connected to the first device body by a hinge provided to a widthwise edge of the first device body so that the second device body can be rotated about the hinge relative to the first device body to be opened and closed with respect to the first device body; a keypad arranged on the second device body and exposed to the outside when the second device body is closed and faces the first device body; and first and second key arrays arranged on the first device body and exposed to the outside when the second device body is rotated and opened from the first device body.

### BRIEF DESCRIPTION OF THE DRAWINGS

The above and other objects, features and advantages of the present invention will be more apparent from the following detailed description taken in conjunction with the accompanying drawings, in which:

FIG. 1 is a perspective view illustrating the front surface of a second device body in a state in which a mobile communication device in accordance with the present invention is closed;

FIG. 2 is a perspective view illustrating the rear surface of a first device body in a state in which the mobile communication device in accordance with the present invention is closed;

FIG. 3 is a perspective view illustrating the front surface of the first device body and the rear surface of the second device body in a state in which the mobile communication device of the present invention is opened about an axis; and

FIG. 4 is a perspective view illustrating the rear surface of the first device body and the front surface of the second device body in a state in which the mobile communication device in accordance with the present invention is opened about the axis.

### DETAILED DESCRIPTION OF THE PREFERRED EMBODIMENTS

Hereinafter, preferred embodiments of the present invention will be described with reference to the accompanying drawings. In the drawings, the same or similar elements are denoted by the same reference numerals even when depicted in different drawings. In the following description, a detailed description of known function and configurations incorporated herein has been omitted for conciseness.

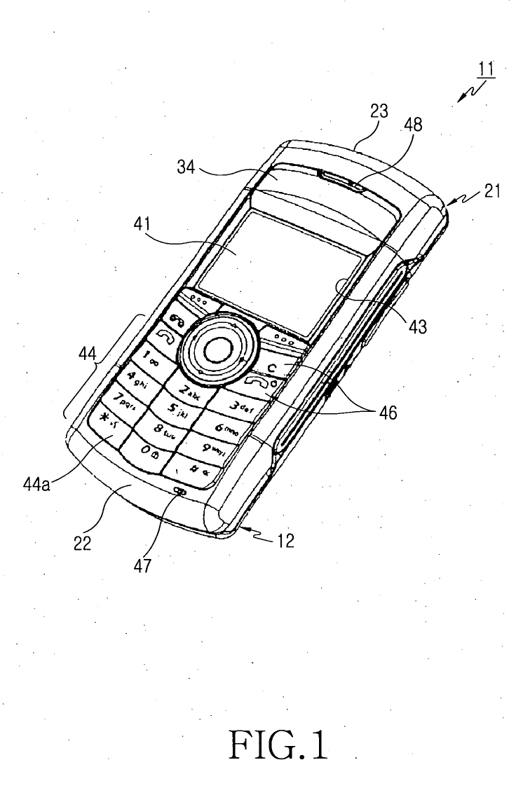

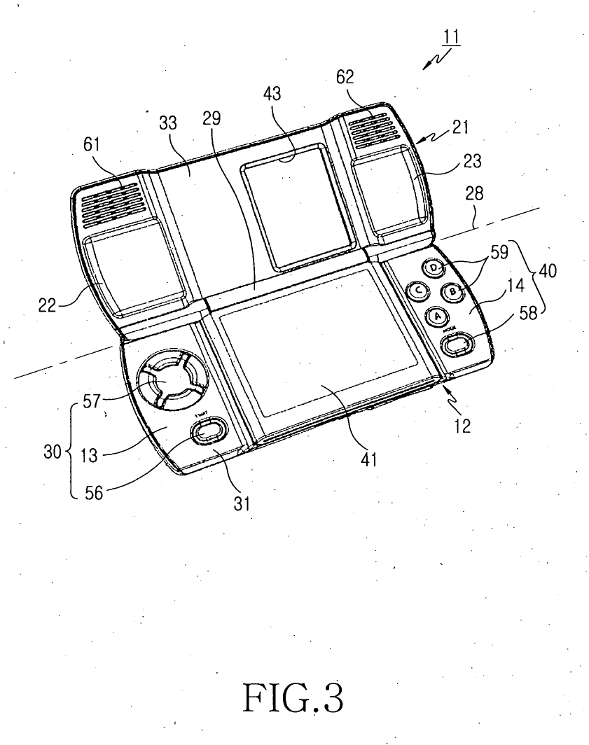

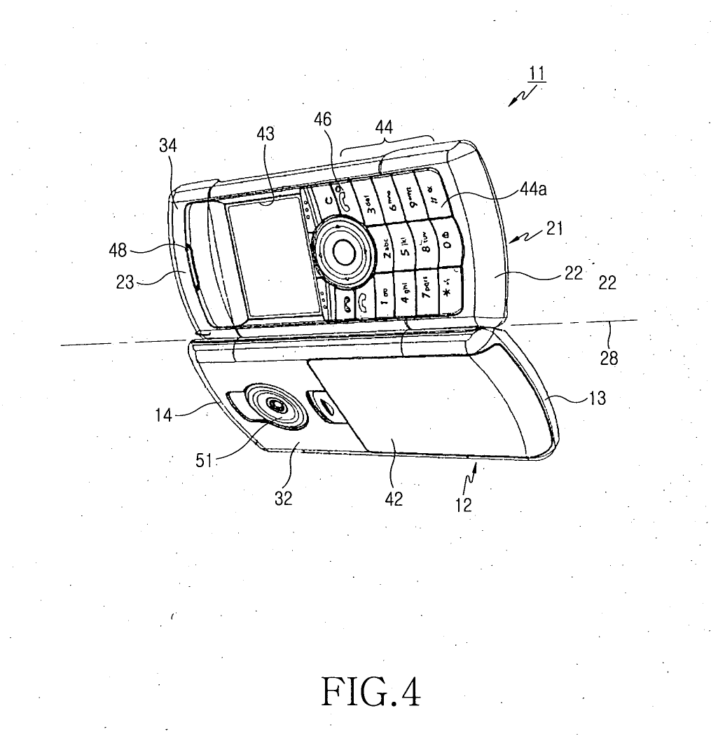

As shown in FIGS. 1 and 4, a mobile communication device 11 in accordance with the present invention includes a first device body 12, a second device body 21, a keypad 44, a first key array 30 and a second key array 40. (FIG. 3) The first device body 12 has an LCD 41. The first device body 12 is elongate in A lengthwise direction thereof.

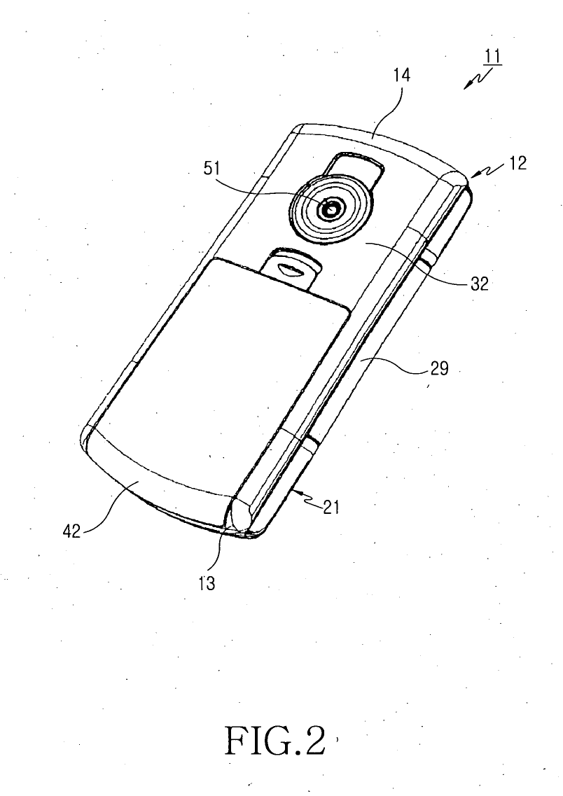

The second device body 21 is placed on the first device body 12 and is rotatably connected to the first device body 12 by a hinge 29 (FIG. 2) provided to one widthwise edge of the first device body 12 so that the second device body 21 can rotate about the axis 28 (FIG. 3) of the hinge 29 relative to the first device body 12 to close and open with respect to the first device body 12 and face toward and face away from the first device body 12. The keypad 44 is provided to the second device body 21 and is always exposed to the outside so that the keypad 44 can be easily used when the mobile communication device 11 is used in a communication mode with the first and second device bodies 12 and 21 facing each other. The first and second key arrays 30 and 40 are provided to the first device body 12 and are exposed to the outside when the second device body 21 is rotated and opened with respect to the first device body 12.

Referring to FIG. 3, the rotation angle of the second device body 21 is preferably in the range of 90°˜180°. The second device body 21 is defined with an opening 43 so that the LCD 41 of the first device body 12 can be viewed through the opening 43 with the first and second device bodies 12 and 21 facing each other. Each of the first and second key arrays 30 and 40 includes at least one key.

Referring to FIGS. 2 and 3, the LCD 41 and the first and second key arrays 30 and 40 are arranged on the front surface 31 of the first device body 12, and a camera lens module 51 and a battery pack 42 are arranged on the rear surface 32 of the first device body 12. The first key array 30 is arranged adjacent to one lengthwise end 13 of the first device body 12, and the second key array 40 is arranged adjacent to the other lengthwise end 14 of the first device body 12. The LCD 41 is arranged between the first and second key arrays 30 and 40.

Referring to FIGS. 1, 3 and 4, the keypad 44, a microphone 47, and a first speaker 48 are arranged on the front surface 34 of the second device body 21, and second and third speakers 61 and 62 are arranged on the rear surface 33 of the second device body 21. The second speaker 61 is arranged adjacent to one lengthwise end 22 of the second device body 21, and the third speaker 62 is arranged adjacent to the other lengthwise end 23 of the second device body 21. The first and second key arrays 30 and 40 include keys dedicated for playing a game. The first key array 30 includes a four directional key 57 and a start key 56, and the second key array 40 includes a manual key 58 and operation keys 59.

Hereafter, operations of the mobile communication device in accordance with the present invention, constructed as mentioned above, will be described in detail with reference to FIGS. 1 through 4.

Referring to FIGS. 1 and 2, when the mobile communication device 11 is used in a communication mode, with the first and second device bodies 12 and 21 facing each other, the keypad 44, the microphone 47 and the first speaker 48 which are arranged on the front surface 34 of the second device body 21 are used. The keypad 44 is provided with a plurality of keys 44a and control keys 46.

At this time, the LCD 41 of the first device body 12 can be viewed through the opening 43 defined in the second device body 21. In this state, a user can implement communication while grasping the mobile communication device using one hand. Another LCD (not shown) may be provided to the second device body 21 in place of the opening 43 so that the mobile communication device 11 can be used as one of a PDA and a bar-type terminal.

Referring to FIGS. 2 and 4, when the mobile communication device 11 is used under a camera mode, the camera lens module 51 arranged on the rear surface 32 of the first device body 12 is used. Therefore, by manipulating the control keys 46 provided to the keypad 44 and converting the operation mode of the mobile communication device 11 into a camera mode, it is possible to photograph a subject desired by a user using the camera lens module 51. Thereafter, the image photographed through the camera lens module 51 is displayed on the LCD 41 of the first device body 12, and the user can view the image appearing on the LCD 41 through the opening 43 of the second device body 21.

Referring to FIG. 3, when the mobile communication device 11 is used in a game mode in which both hands of the user are used, the second device body 21 is rotated about the axis 28 of the hinge 29 and is opened with respect to the first device body 12 to face away from the first device body 12. The first and second key arrays 30 and 40 are thereby respectively arranged adjacent to both lengthwise ends 13 and 14 of the first device body 12, are exposed to the outside. Simultaneously, the LCD 41 arranged between the first and second key arrays 30 and 40 is also exposed to the outside. Each of the first and second key arrays 3 and 40 includes at least one key dedicated for playing a game. The first key array 30 includes the four directional key 57 and the start key 56, and the second key array 40 includes the manual key 58 and the operation keys 59.

If the second device body 21 is rotated from the first device body 12 as described above, the LCD 41 and the first and second key arrays 30 and 40 of the first device body 12 are exposed to the outside, and at the same time, the second and third speakers 61 and 62 which are respectively arranged adjacent to both lengthwise ends 22 and 23 of the rear surface 33 of the second device body 21 are also exposed to the outside. In this state, the user can press the start key 56 of the first key array 30 using one hand and the operation keys 59 of the second key array 40 using the other hand. Thereafter, by pressing the four directional key 57 of the first key array 30 using one hand and the operation keys 59 of the second key array 40 using the other hand, the user can play a game while watching the LCD 41 of the first device body 12.

As such, with the second device body 21 closed, the mobile communication device 11 can be conveniently carried, can immediately implement communication under a communication mode, and can also be used under a PDA mode and a camera mode. Further, with the second device body 21 opened, the mobile communication device 11 can be used under a game mode in which both hands of the user are used.

Hence, if the second device body 21 is opened from the first device body 12 through rotation about the hinge axis 28 extending in the lengthwise direction of the mobile communication device 11, all of the front and rear surfaces of the mobile communication device 11 can be used, and the front surface 31 of the first device body 12 and the rear surface 33 of the second device body 21 can also be used together.

While the invention has been shown and described with reference to specific embodiments thereof, it will be understood by those skilled in the art that various changes in form and details may be made therein without departing from the spirit and scope of the invention as defined by the appended claims.

What is claimed is:

1. A mobile communication device comprising:
a first device body having a Liquid Crystal Display (LCD) and being elongate in a lengthwise direction thereof;
a second device body rotatably connected to the first device body by a hinge provided to a widthwise edge of the first device body so that the second device body can rotate about the hinge relative to the first device body to open and close with respect to the first device body;
a keypad arranged on the second device body and exposed to the outside when the second device body is closed and faces the first device body; and
first and second key array arranged on the first device body and exposed to the outside when the second device body is rotated and opened from the first device body.

2. The mobile communication device as set forth in claim 1, wherein the second device body is defined with an opening so that the LCD of the first device body can be viewed through the opening with the first and second device bodies facing each other.

3. The mobile communication device as set forth in claim 1, wherein each of the first key array and the second key array comprises at least one key.

4. The mobile communication device as set forth in claim 1, wherein the LCD and the first and second key arrays are arranged on a front surface of the first device body, and a camera lens module and a battery pack are arranged on a rear surface of the first device body.

5. The mobile communication device as set forth in claim 1, wherein the first key array and the second key array are respectively arranged adjacent to both lengthwise ends of the first device body, and the LCD is arranged between the first key array and the second key array.

6. The mobile communication device as set forth in claim 1, wherein the keypad, a microphone, and a first speaker are arranged on a front surface of the second device body, and a second speaker and a third speaker are arranged on a rear surface of the second device body.

7. The mobile communication device as set forth in claim 6, wherein the second and third speakers dedicated for a game mode are arranged adjacent to both lengthwise ends of the second device body.

8. The mobile communication device as set forth in claim 1, wherein the first array and the second key array comprise keys dedicated for playing a game, the first key array includes a four directional key and a start key, and the second key array includes a manual key and operation keys.

9. The mobile communication device as set forth in claim 1, wherein a rotation angle of the second device body is defined in the range of 90°˜180°.

10. The mobile communication device as set forth in claim 4, wherein:
when the mobile communication device is used under a communication mode, the keypad, the microphone and the first speaker arranged on the front surface of the first device body are used with the first and second device bodies facing each other;
when the mobile communication device is used under a camera mode, the camera lens module arranged on the rear surface of the first device body is used with the first and second device bodies facing each other to photograph a subject; and
when the mobile communication device is used under a game mode, the second device body is rotated from the first device body about an axis of the hinge to be opened with respect to the first device body so that the rear surface of the second device body and the front surface of the first device body are exposed to the outside, and the second and third speakers, the LCD and the first and second key arrays are used so that the first and second key arrays are manipulated using both hands of a user.

11. The mobile communication device as set forth in claim 6, wherein:
when the mobile communication device is used under a communication mode, the keypad, the microphone and the first speaker arranged on the front surface of the first device body are used with the first and second device bodies facing each other;
when the mobile communication device is used under a camera mode, the camera lens module arranged on the rear surface of the first device body is used with the first and second device bodies facing each other to photograph a subject; and
when the mobile communication device is used under a game mode, the second device body is rotated from the first device body about an axis of the hinge to be opened with respect to the first device body so that the rear surface of the second device body and the front surface of the first device body are exposed to the outside, and the second and third speakers, the LCD and the first and second key arrays are used so that the first and second key arrays are manipulated using both hands of a user.

12. A mobile communication device comprising:
a first device body having a plurality of key arrays; and
a second device body rotatably connected to the first device body so that the second device body can be rotated about a hinge relative to the first device body to face toward or face away from the first device body, and, when the second device body faces the first device body, a keypad arranged on a front surface of the second device body can be used, and, when the second device body is rotated to be opened with respect to the first device body, the key arrays are exposed to the outside to be manipulated using both hands of a user.
